(19) United States
(12) Patent Application Publication
(10) Pub. No.: US 2022/0069509 A1
(43) Pub. Date: Mar. 3, 2022

(54) CONNECTOR

(71) Applicant: SUMITOMO WIRING SYSTEMS, LTD., Mie (JP)

(72) Inventors: Yukihiro FUKATSU, Mie (JP); Shinji IIHOSHI, Mie (JP); Tomohisa UCHIDA, Mie (JP); Takeshi SUZUKI, Mie (JP)

(21) Appl. No.: 17/408,815

(22) Filed: Aug. 23, 2021

(30) Foreign Application Priority Data
Aug. 27, 2020 (JP) 2020-143812

(51) Int. Cl. H01R 13/506; H01R 13/52

(52) U.S. Cl. CPC H01R 13/506; H01R 13/424; H01R 13/5202

(57) ABSTRACT

A connector A is provided with a pair of housings 10, 30 each including a plurality of terminal accommodation chambers 12, 32 arranged in a width direction, the housings 10, 30 being stacked and assembled such that arrangement directions of the terminal accommodation chambers 12, 32 are parallel to each other, communicating portions 23, 37 open in facing surfaces 21, 35 of the pair of housings 10, 30 facing each other and allowing the terminal accommodation chambers 12, 32 adjacent in the width direction to communicate with each other, a plurality of terminal fittings 15 connected to front end parts of wires 14 and individually accommodated in the plurality of terminal accommodation chambers 12, 32, and recesses 24, 38 formed in regions in front of front ends of the communicating portions 23, 37, out of the facing surfaces 21, 35.

### CROSS-REFERENCE TO RELATED APPLICATIONS

This application is based on and claims priority from Japanese Patent Application No. 2020-143812, filed on Aug. 27, 2020, with the Japan Patent Office, the disclosure of which is incorporated herein in their entireties by reference.

### TECHNICAL FIELD

The present disclosure relates to a connector.

### BACKGROUND

U.S. Pat. No. 9,722,347 discloses a connector including two flat housings and a plurality of terminal fittings accommodated in parallel in terminal accommodation chambers of the respective housings. The two housings are assembled in a stacked state. Openings for partially exposing the terminal accommodation chambers are formed in facing surfaces of the two housings facing each other.

### SUMMARY

Since the stacked housings are coupled on both widthwise end parts, the both housings may be curved and deformed to be open in a widthwise central part when an external force acts on a bundle of wires connected to the terminal fittings. If the housings are separated, there is a concern that a clearance is formed between the facing surfaces of the both housings and an external matter having entered this clearance contacts the terminal fittings in the openings.

A connector of the present disclosure was completed on the basis of the above situation and aims to prevent the contact of external matters with terminal fittings.

The present disclosure is directed to a connector with a pair of housings each including a plurality of terminal accommodation chambers arranged in a width direction, the housings being stacked and assembled such that arrangement directions of the terminal accommodation chambers are parallel to each other, communicating portions open in facing surfaces of the pair of housings facing each other, the communicating portions allowing the terminal accommodation chambers adjacent in the width direction to communicate with each other, a plurality of terminal fittings connected to front end parts of wires, the plurality of terminal fittings being individually accommodated in the plurality of terminal accommodation chambers, and recesses formed in regions in front of front ends of the communicating portions, out of the facing surfaces.

According to the present disclosure, it is possible to prevent the contact of external matters with terminal fittings.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a front view of a connector of a first embodiment.

FIG. 2 is a section along X-X of FIG. 1.

FIG. 3 is a partial enlarged plan view of a lower housing.

FIG. 4 is a partial enlarged bottom view of an upper housing.

FIG. 5 is a front view of a connector of a second embodiment.

FIG. 6 is a section along Y-Y of FIG. 5.

FIG. 7 is a partial enlarged section of FIG. 6.

FIG. 8 is a partial enlarged plan view of a lower housing.

FIG. 9 is a partial enlarged bottom view of an upper housing.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

(1) The connector of the present disclosure is provided with a pair of housings each including a plurality of terminal accommodation chambers arranged in a width direction, the housings being stacked and assembled such that arrangement directions of the terminal accommodation chambers are parallel to each other, communicating portions open in facing surfaces of the pair of housings facing each other, the communicating portions allowing the terminal accommodation chambers adjacent in the width direction to communicate with each other, a plurality of terminal fittings connected to front end parts of wires, the plurality of terminal fittings being individually accommodated in the plurality of terminal accommodation chambers, and recesses formed in regions in front of front ends of the communicating portions, out of the facing surfaces. According to the configuration of the present disclosure, even if an external matter intrudes into a clearance between the facing surfaces from the front of the housings when the both housings are deformed to separate the facing surfaces from each other, the external matter having intruded into the clearance is accommodated in the recess before reaching the communicating portion. Thus, there is no possibility that the external matter intrudes into the terminal accommodation chamber from the communicating portion. In this way, the contact of the external matter with the terminal fitting in the terminal accommodation chamber can be prevented.

(2) Preferably, a formation range of the recess in a front-rear direction is only a region behind a front surface of the housing. According to this configuration, since the recesses are not open in the front surfaces of the housings, external matters do not intrude into the recesses in a state where the facing surfaces are not separated.

(3) Preferably, the recesses are open in front surfaces of the pair of housings, and the recesses formed in one housing and the recesses formed in the other housing are disposed in mutually different regions in the width direction. According to this configuration, external matters are less likely to intrude into a clearance between the both housings as compared to the case where the recesses of the one housing and the recesses of the other housing are disposed in the same regions in the width direction.

Preferably, a formation range of the recess in the width direction is only a formation region of a partition wall portion defining two adjacent terminal accommodation chambers. According to this configuration, since opening widths of the recesses in the front surfaces of the housings are small, the intrusion of long external matters into the clearance between the facing surfaces can be prevented.

### Details of Embodiments of Present Disclosure

### First Embodiment

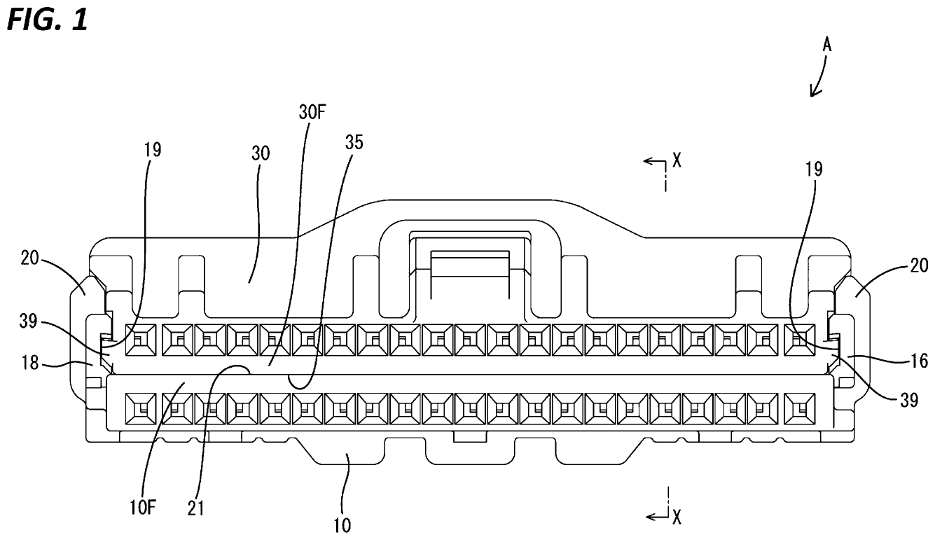

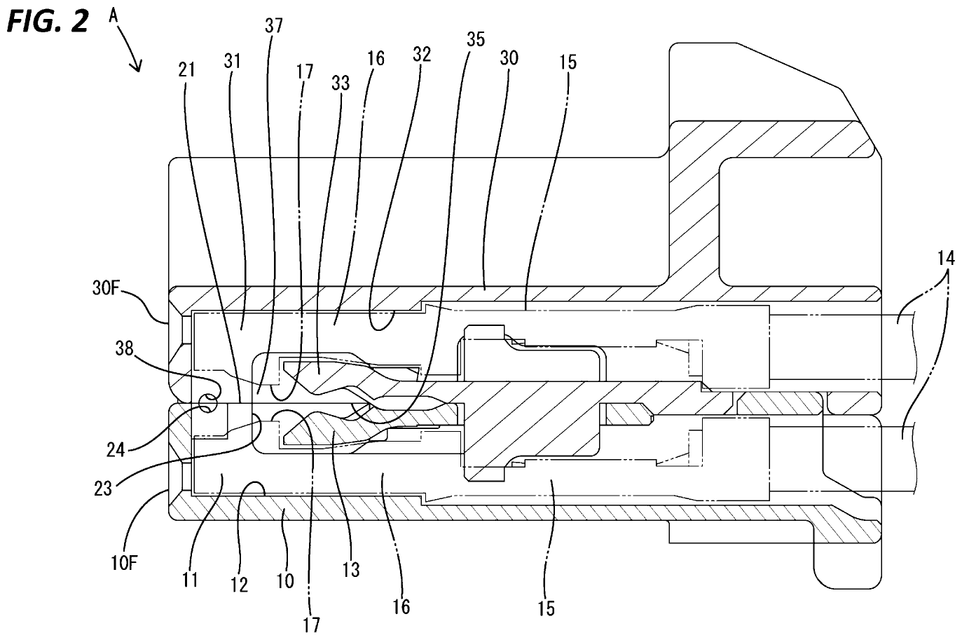

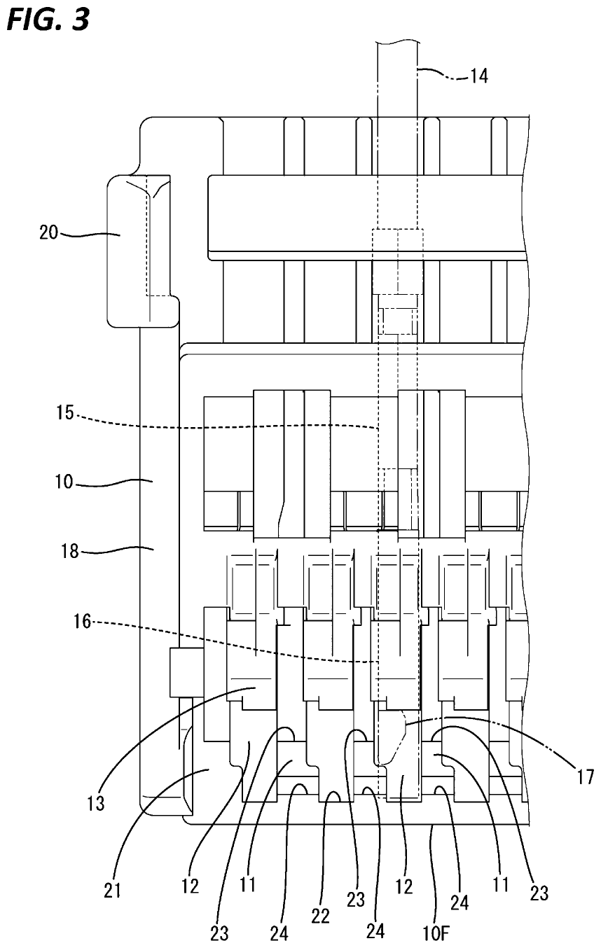

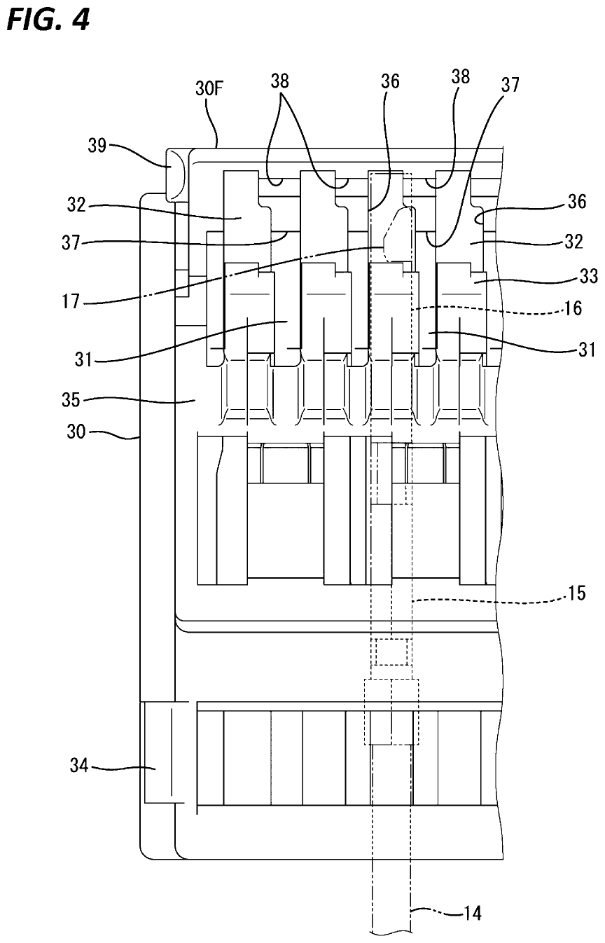

A first specific embodiment of a connector of the present disclosure is described with reference to FIGS. 1 to 4. Note that the present invention is not limited to these illustrations and is intended to be represented by claims and include all changes in the scope of claims and in the meaning and scope of equivalents. In the first embodiment, a left side in FIG. 2, a lower side in FIG. 3 and an upper side in FIG. 4 are defined as a front side concerning a front-rear direction. Upper and lower sides shown in FIGS. 1 and 2 are directly defined as upper and lower sides concerning a vertical direction. Left and right sides shown in FIGS. 1, 3 and 4 are directly defined as left and right sides concerning a lateral direction.

A connector A of the first embodiment includes a lower housing 10 made of synthetic resin, an upper housing 30 made of synthetic resin and a plurality of terminal fittings 15 fixed to front end parts of wires 14. Both the lower housing 10 and the upper housing 30 have a flat shape having a vertical dimension smaller than a width in the lateral direction. The lower and upper housings 10, 30 are assembled in a stacked state by placing the upper housing 30 on the lower housing 10. The lower and upper housings 10, 30 are locked so as not be separated from each other only on both widthwise end parts.

As shown in FIG. 3, a plurality of lower-side terminal accommodation chambers 12 defined by lower-side partition wall portions 11 are formed at fixed intervals in the lateral direction in the lower housing 10. A locking lance 13 is formed in each lower-side terminal accommodation chamber 12. The terminal fitting 15 is inserted into the lower-side terminal accommodation chamber 12 from behind the lower housing 10. A rectangular tube portion 16 is formed in a front end part of the terminal fitting 15 and a retaining projection 17 is formed on an outer surface of the rectangular tube portion 16. The terminal fitting 15 inserted in the lower-side terminal accommodation chamber 12 is held retained by having the retaining projection 17 locked by the locking lance 13. As shown in FIG. 1, the lower housing 10 includes a pair of side wall portions 18. A pair of locking recesses 19 are formed in front end parts of the inner surfaces of the both side wall portions 18. A pair of resilient lock pieces 20 are formed on rear end parts of the both side wall portions 18.

The upper surface of the lower housing 10 serves as a lower-side facing surface 21 facing the upper housing 30. As shown in FIGS. 2 and 3, a plurality of lower-side openings 22 and a plurality of lower-side communicating portions 23 are formed in a front end part of the lower-side facing surface 21. The lower-side openings 22 expose the front end parts and the retaining projections 17 of the terminal fittings 15 accommodated in the lower-side terminal accommodation chambers 12 in the lower-side facing surface 21. The lower-side communicating portions 23 are formed by cutting upper end parts of the lower-side partition wall portions 11 between the lower-side terminal accommodation chambers 12, and allow adjacent ones of the lower-side terminal accommodation chambers 12 to communicate with each other.

The lower-side facing surface 21 is formed with a plurality of lower-side recesses 24. The lower-side recess 24 is formed in a front end part of the lower-side partition wall portion 11. A formation range of the lower-side recess 24 in a length direction (front-rear direction) of the terminal fitting 15 is a region in front of the lower-side communicating portion 23 and behind a front surface 10F of the lower housing 10. The lower-side recess 23 allows front end parts of the lower-side openings 22 to communicate with each other, but is located in front of the retaining projection 17 of the terminal fitting 15. In a side view of the lower housing 10 viewed in an arrangement direction (lateral direction) of the terminal fittings 15, the lower-side recess 24 has a semicircular shape (see FIG. 2).

A plurality of upper-side terminal accommodation chambers 32 defined by upper-side partition wall portions 31 are formed at fixed intervals in the lateral direction in the upper housing 30. A locking lance 33 is formed in each upper-side terminal accommodation chamber 32. The terminal fitting 15 is inserted into the upper-side terminal accommodation chamber 32 from behind the upper housing 30. The terminal fitting 15 to be inserted into the upper housing 30 is the same component as the terminal fitting 15 to be inserted into the lower housing 10. The terminal fitting 15 inserted in the upper-side terminal accommodation chamber 32 is held retained by having the retaining projection 17 locked by the locking lance 33. As shown in FIG. 4, a pair of locking projections 39 are formed on front end parts of both left and right outer side surfaces of the upper housing 30. A pair of lock projections 34 are formed on rear end parts of the both left and right outer side surfaces.

The lower surface of the upper housing 30 serves as an upper-side facing surface 35 facing the lower housing 10. A plurality of upper-side openings 36 and a plurality of upper-side communicating portions 37 are formed in a front end part of the upper-side facing surface 35. The upper-side openings 36 expose front end parts and the retaining projections 17 of the terminal fittings 15 accommodated in the upper-side terminal accommodation chambers 32 in the upper-side facing surface 35. The upper-side communicating portions 37 are formed by cutting lower end parts of the upper-side partition wall portions 31 between the upper-side terminal accommodation chambers 32, and allow adjacent ones of the upper-side terminal accommodation chambers 32 to communicate with each other.

The upper-side facing surface 35 is formed with a plurality of upper-side recesses 38. The upper-side recess 38 is formed in a front end part of the upper-side partition wall portion 31. A formation range of the upper-side recess 38 in the length direction (front-rear direction) of the terminal fitting 15 is a region in front of the upper-side communicating portion 37 and behind a front surface 30F of the upper housing 30. The upper-side recess 38 allows front end parts of the upper-side openings 36 to communicate with each other, but is located in front of the retaining projection 17 of the terminal fitting 15. In a side view of the upper housing 30 viewed in the arrangement direction (lateral direction) of the terminal fittings 15, the upper-side recess 38 has a semicircular shape (see FIG. 2). The upper-side recess 38 is arranged at the same position as the lower-side recess 24 in the front-rear direction. The lower-side recess 24 and the upper-side recess 38 constitute one hole portion circular in a side view.

The lower and upper housings 10, 30 assembled in the stacked state are held assembled by the locking of the locking recesses 19 and the locking projections 39 and the locking of the resilient lock pieces 20 and the locking projections 34. Since the both housings 10, 30 are locked only on both end parts in the lateral direction, if a vertical external force acts on a bundle of the wires 14 drawn out rearward of the both housings 10, 30, the both housings 10, 30 are possibly resiliently curved and deformed to vertically separate laterally central parts of the lower-side facing surface 21 and the upper-side facing surface 35.

If the both housings 10, 30 are deformed as described above, an external matter (not shown) such as a metal piece may intrude into a clearance between the both housings 10 and 30 from the front of the both housings 10, 30 and enter the lower-side communicating portion 23 to contact the terminal fitting 15 between the adjacent lower-side terminal accommodation chambers 12. However, since the lower-side facing surface 21 is formed with the lower-side recesses 24 by being recessed in front of the lower-side communicating portions 23, the external matter having intruded into the clearance between the both housings 10 and 30 drops into the lower-side recess 24 and does not reach the lower-side communicating portion 23.

Further, if the both housings 10, 30 are separated while being vertically inverted, an external matter having intruded into the clearance between the both housings 10, 30 from the front of the both housings 10, 30 may enter the upper-side communicating portion 37 to contact the terminal fitting 15 between the adjacent upper-side terminal accommodation chambers 32. However, also in this case, since the upper-side facing surface 35 is formed with the upper-side recesses 38 by being recessed in front of the upper-side communicating portions 37, the external matter having intruded into the clearance between the both housings 10 and 30 drops into the upper-side recess 38 and does not reach the upper-side communicating portion 37.

The connector A of the first embodiment includes the pair of housings (lower housing 10 and upper housing 30). The lower housing 10 includes the plurality of lower-side terminal accommodation chambers 12 arranged in the width direction (lateral direction), and the upper housing 30 includes the plurality of upper-side terminal accommodation chambers 32 arranged in the width direction (lateral direction). The plurality of terminal fittings 15 connected to the front end parts of the wires 14 are individually accommodated in the plurality of lower-side terminal accommodation chambers 12 and the plurality of upper-side terminal accommodation chambers 32. The both housings 10, 30 are stacked and assembled such that the arrangement directions of the lower-side terminal accommodation chambers 12 and the upper-side terminal accommodation chambers 32 are parallel to each other.

The lower housing 10 includes the lower-side communicating portions 23 open in the lower-side facing surface 21 facing the upper housing 30 and allowing the lower-side terminal accommodation chambers 12 adjacent in the width direction to communicate with each other. The upper housing 30 includes the upper-side communicating portions 37 open in the upper-side facing surface 35 facing the lower housing 10 and allowing the upper-side terminal accommodation chambers 32 adjacent in the width direction to communicate with each other. The lower-side recesses 24 are formed in the region in front of the front ends of the lower-side communicating portions 23, out of the lower-side facing surface 21. The upper-side recesses 38 are formed in the region in front of the front ends of the upper-side communicating portions 37, out of the upper-side facing surface 35.

According to the above configuration, even if an external matter intrudes into a clearance between the lower-side facing surface 21 and the upper-side facing surface 35 from front when the both housings 10, 30 are deformed to separate the lower-side facing surface 21 and the upper-side facing surface 35, the external matter having intruded into the clearance is accommodated into the lower-side recess 24 or the upper-side recess 38 before reaching the lower-side communicating portion 23 or the upper-side communicating portion 37. Thus, there is no possibility that the external matter having intruded into the clearance between the both housings 10 and 30 intrudes into the lower-side terminal accommodation chamber 12 from the lower-side communicating portion 23 or intrudes into the upper-side terminal accommodation chamber 32 from the upper-side communicating portion 37. According to the connector A of the first embodiment, the contact of external matters with the terminal fittings 15 in the lower-side terminal accommodation chambers 12 and the terminal fittings 15 in the upper-side terminal accommodation chambers 32 can be prevented.

Since the formation range of the lower-side recess 24 in the front-rear direction is only the region behind the front surface 10F of the lower housing 10, the lower-side recess 24 is not open in the front surface 10F of the lower housing 10. Further, since the formation range of the upper-side recess 38 in the front-rear direction is only the region behind the front surface 30F of the upper housing 30, the upper-side recess 38 is not open in the front surface 30F of the upper housing 30. Therefore, external matters do not intrude into the lower-side recesses 24 and the upper-side recesses 38 in a state where the lower-side facing surface 21 and the upper-side facing surface 35 are not separated.

### Second Embodiment

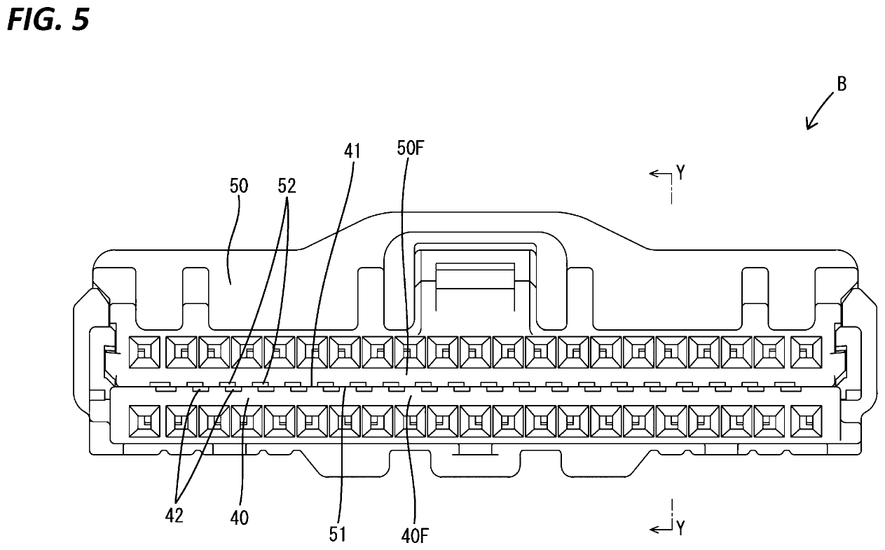

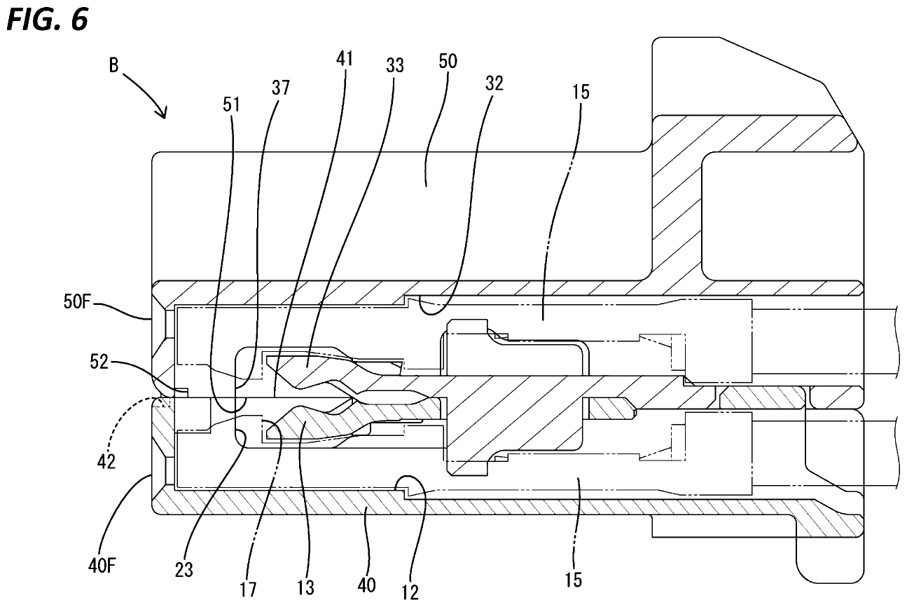

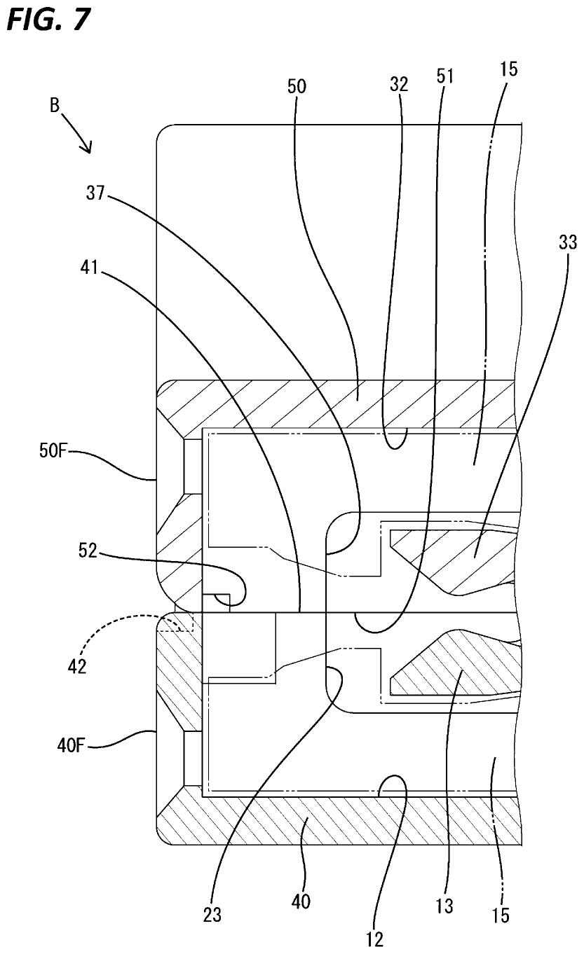

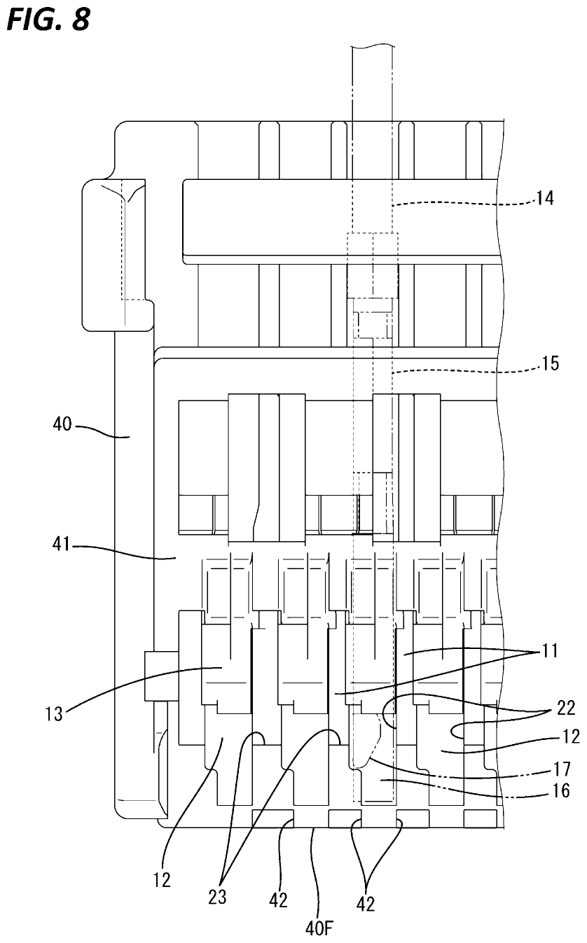

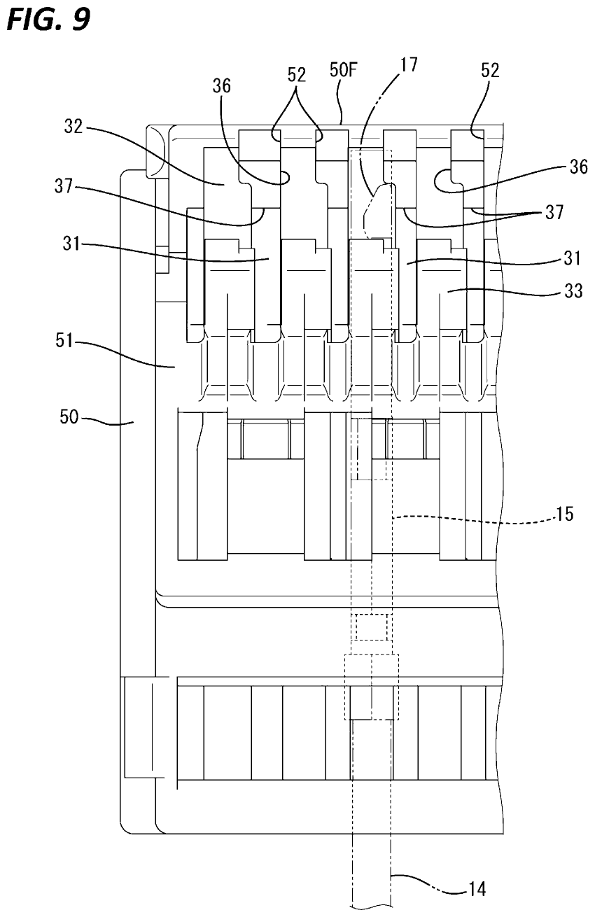

A second specific embodiment of the connector of the present disclosure is described with reference to FIGS. 5 to 9. A connector B of the second embodiment differs from the first embodiment in the configurations of lower-side recesses 42 of a lower housing 40 and upper-side recesses 52 of an upper housing 50. Since the other components are the same as in the first embodiment, the same components are denoted by the same reference signs and the structures, functions and effects thereof are not described. In the second embodiment, a left side in FIGS. 6 and 7, a lower side in FIG. 8 and an upper side in FIG. 9 are defined as a front side concerning a front-rear direction. Upper and lower sides shown in FIGS. 5 to 7 are directly defined as upper and lower sides concerning a vertical direction. Left and right sides shown in FIGS. 5, 8 and 9 are directly defined as left and right sides concerning a lateral direction.

As shown in FIG. 8, the lower-side recesses 42 formed in a lower-side facing surface 41 of the lower housing 40 are open in a front surface 40F of the lower housing 40. A formation region of the lower-side recess 42 in the lateral direction is a range corresponding to a lower-side partition wall portion 11 and between the front ends of lower-side openings 22. In a plan view of the lower housing 40, the lower-side recess 42 has a rectangular shape long in the lateral direction. A formation region of the lower-side recess 42 in the front-rear direction is a range in front of the front end of a lower-side communicating portion 23 and in front of the lower-side opening 22.

As shown in FIG. 9, the upper-side recesses 52 formed in an upper-side facing surface 51 of the upper housing 50 are open in a front surface 50F of the upper housing 50. A formation region of the upper-side recess 52 in the lateral direction is a range corresponding to an upper-side partition wall portion 31 and between the front ends of upper-side openings 36. In a bottom view of the upper housing 50, the upper-side recess 52 has a rectangular shape long in the lateral direction. A formation region of the upper-side recess 52 in the front-rear direction is a range in front of the front end of an upper-side communicating portion 37 and in front of the upper-side opening 36.

As shown in FIG. 5, in a front view of the both housings 40, 50, the lower-side recesses 42 and the upper-side recesses 52 are shifted in the lateral direction with the both housings 40, 50 stacked and assembled. In particular, left regions of the lower-side recesses 42 and right regions of the upper-side recesses 52 vertically communicate. Right end parts of the lower-side recesses 42 are closed by the upper-side facing surface 51, and left end parts of the upper-side recesses 52 are closed by the lower-side facing surface 41.

In the connector B of the second embodiment, the lower-side recesses 42 and the upper-side recesses 52 are formed to be open in the front surface 40F of the lower housing 40 and the front surface 50F of the upper housing 50. The lower-side recesses 42 formed in the lower housing 40 and the upper-side recesses 52 formed in the upper housing 50 are disposed in regions mutually different from each other in the width direction. According to this configuration, external matters are less likely to intrude into a clearance between the both housings 40 and 50 as compared to the case where the lower-side recesses 42 of the lower housing 40 and the upper-side recesses 52 of the upper housing 50 are disposed in the same regions in the width direction.

The formation range of the lower-side recess 42 in the width direction is only a formation region of the lower-side partition wall portion 11 defining two adjacent lower-side terminal accommodation chambers 12. The formation range of the upper-side recess 52 in the width direction is only a formation region of the upper-side partition wall portion 31 defining two adjacent upper-side terminal accommodation chambers 32. According to this configuration, since both opening widths of the lower-side recesses 42 in the front surface 40F of the lower housing 40 and opening widths of the upper-side recess 52 in the front surface 50F of the upper housing 50 are small, the intrusion of long external matters into a clearance between the lower-side facing surface 41 and the upper-side facing surface 51 can be prevented.

### Other Embodiments

The present invention is not limited to the first and second embodiments described and illustrated above and is represented by claims. The present invention is intended to include all changes in the scope of claims and in the meaning and scope of equivalents and include also the following embodiments.

Although the recesses have a semicircular cross-sectional shape in the first embodiment, the recesses may have a semi-oval shape, a semi-elliptical shape, a rectangular shape or the like.

Although the back end surfaces of the recesses are flat surfaces orthogonal to the front-rear direction in the second embodiment, the back end surfaces of the recesses may be flat or curved surfaces inclined with respect to the front-rear direction.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a pair of housings each including a plurality of terminal accommodation chambers arranged in a width direction, the housings being stacked and assembled such that arrangement directions of the terminal accommodation chambers are parallel to each other;
communicating portions open in facing surfaces of the pair of housings facing each other, the communicating portions allowing the terminal accommodation chambers adjacent in the width direction to communicate with each other;
a plurality of terminal fittings connected to front end parts of wires, the plurality of terminal fittings being individually accommodated in the plurality of terminal accommodation chambers; and
recesses formed in regions in front of front ends of the communicating portions, out of the facing surfaces.

2. The connector of claim 1, wherein a formation range of the recess in a front-rear direction is only a region behind a front surface of the housing.

3. The connector of claim 1, wherein:
the recesses are open in front surfaces of the pair of housings, and
the recesses formed in one housing and the recesses formed in the other housing are disposed in mutually different regions in the width direction.

4. The connector of claim 3, wherein a formation range of the recess in the width direction is only a formation region of a partition wall portion defining two adjacent terminal accommodation chambers.
